(19) United States
(12) Patent Application Publication
(10) Pub. No.: US 2018/0264633 A1
(43) Pub. Date: Sep. 20, 2018

(54) Automobile Light Wrench

(71) Applicant: Kevin Miller, Beardstown, IL (US)

(72) Inventor: Kevin Miller, Beardstown, IL (US)

(21) Appl. No.: 15/923,937

(22) Filed: Mar. 16, 2018

Related U.S. Application Data
(60) Provisional application No. 62/472,398, filed on Mar. 16, 2017.

(51) Int. Cl. B25B 27/00; B25B 13/48; B25G 1/10; B25B 23/00

(52) U.S. Cl. CPC B25B 27/0035; B25B 13/481; B25B 13/46; B25B 23/0007; B25G 1/102

(57) ABSTRACT

An automobile light wrench that is utilized to swap out automobile bulbs within headlights, signal lights, tail lights, fog lights, and auxiliary lights includes a handle, an elongated body, and an open-end wrench head. The open-end wrench head comprises a cross member, a first fixed-jaw, and a second fixed-jaw. The first fixed-jaw is terminally connected to the cross member. The second fixed-jaw is terminally connected to the cross member, opposite of the first fixed-jaw. The elongated body is terminally connected to the handle from one as the elongated body is terminally connected to the cross member, opposite of the handle. The elongated body is positioned in between the first fixed-jaw and the second fixed-jaw thus orienting the first fixed-jaw and the second fixed-jaw away from the elongated body. An inner seat profile of the open-end wrench head engages around the automobile bulb base to facilitate the removal and installation process.

The current application claims a priority to the U.S. Provisional Patent application Ser. No. 62/472,398 filed on Mar. 16, 2017.

### FIELD OF THE INVENTION

The present invention relates generally to an automobile light wrench. More specifically, the present invention is intended to be predominantly utilized in uninstalling and installing an automobile bulb of a light housing without having to put user's hands into a congested area behind the light housing.

### BACKGROUND OF THE INVENTION

Swapping out automobile bulbs within headlights, signal lights, tail lights, fog lights, and auxiliary lights can be a hassle for those not versed in garage work or natural ‘grease monkey’ predilections. Despite the fact the bulbs are commercially available to purchase, there is not a tool that addresses the specific need of the consumer on a budget to remove a worn-out bulb and then replace it with a newer bulb. As a result, users normally use their hands to remove and replace the worn-out bulb. However, depending upon the model of the vehicle, users may find it difficult reach the worn-out bulb to use their hands if the area behind the light housing is congested or hard to reach.

It is therefore an objective of the present invention to provide an automobile light wrench to assist the removal of the worn-out bulb and replacement of the newer bulb. More specifically, the present invention seeks to address this need by providing a wrench head that is designed for a plurality of known automobile bulb base categories and may be prepared in an assortment of lengths. As a result, the present invention can eliminate aggressive wire harness pullout that can normally happen when users use their hands to swap out the automobile bulbs and damages to the automobile bulbs that can cause by not having a proper grip. Additionally, the present invention provides the greatest benefit to the removal and replacement of automobile bulbs for those with larger digits or inarticulate fingers.

### BRIEF DESCRIPTION OF THE DRAWINGS

FIG. 1 is a perspective view of the preferred embodiment of the present invention.

FIG. 2 is a front view of the preferred embodiment of the present invention.

FIG. 3 is a front view of the preferred embodiment of the present invention, showing the straight edge, the first concave edge, and the second concave edge within the inner seat profile.

FIG. 4 is a top view of the preferred embodiment of the present invention.

FIG. 5 is a front view of the preferred embodiment of the present invention showing the distal distance and the proximal distance.

FIG. 6 is an alternative embodiment of the present invention showing the telescopic elongated body.

### DETAIL DESCRIPTIONS OF THE INVENTION

All illustrations of the drawings are for the purpose of describing selected versions of the present invention and are not intended to limit the scope of the present invention.

The present invention is an automobile light wrench that is capable of removing or installing an automobile bulb within a light housing. The light housing can include, but is not limited to headlights, signal lights, tail lights, fog lights, and auxiliary lights within an automobile. The present invention functions as a tool for swapping out the automobile bulb that is traditionally done by the hand. Resultantly, the present invention eliminates potential damages that may happen to the light housing, the automobile bulb, and the wire harness of the light housing during the swapping out process of the automobile bulb.

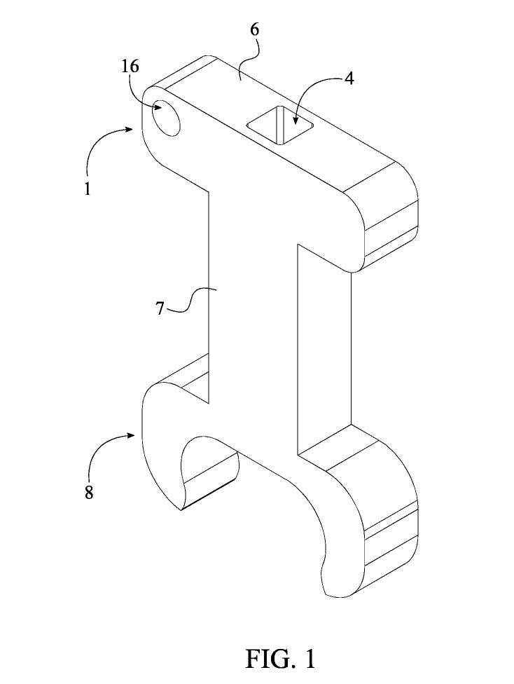

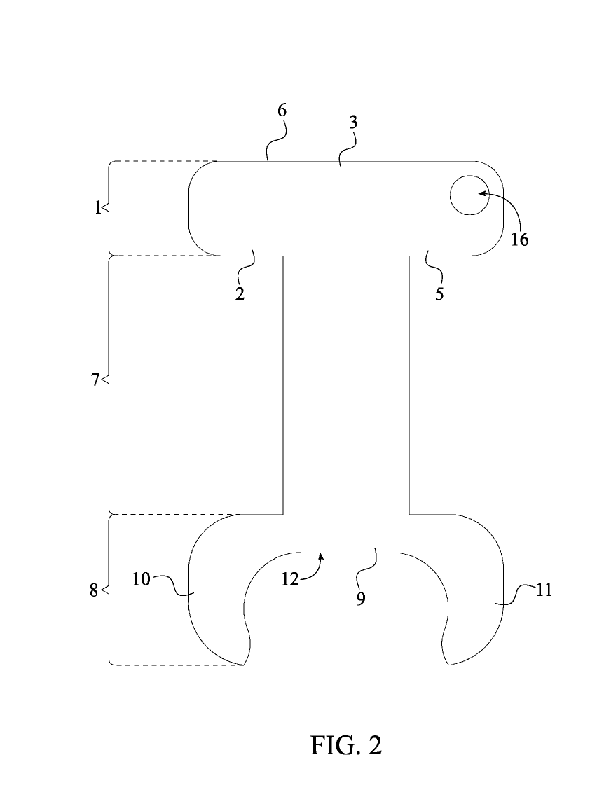

The present invention comprises a handle 1, an elongated body 7, an open-end wrench head 8 as shown in FIG. 1. The open-end wrench head 8 comprises a cross member 9, a first fixed-jaw 10, and a second fixed-jaw 11 as shown in FIG. 2. In reference to the general configuration of the present invention, the first fixed-jaw 10 is terminally connected to the cross member 9. The second fixed-jaw 11 is terminally connected to the cross member 9 and positioned opposite of the first fixed-jaw 10. As a result, the first fixed-jaw 10, the second fixed-jaw 11, and the cross member 9 delineate the general shape of the open-end wrench head 8 that is supposed to tightly engage around the automobile bulb base. The elongated body 7 is a continuous body with a fixed length and determines the overall length for a preferred embodiment of the present invention. More specifically, the elongated body 7 is terminally connected to the handle 1 from one end. The elongated body 7 is also terminally connected to the cross member 9 from the opposite end as the cross member 9 is oppositely positioned of the handle 1. The first fixed-jaw 10 and the second fixed-jaw 11 are oriented away from the elongated body 7 so that the open-end wrench head 8 can easily position around the automobile bulb base without any interference from the elongated body 7. The elongated body 7 is positioned in between the first fixed-jaw 10 and the second fixed-jaw 11 so that the present invention can maximize the left and right angular displacement of the present invention about the automobile bulb.

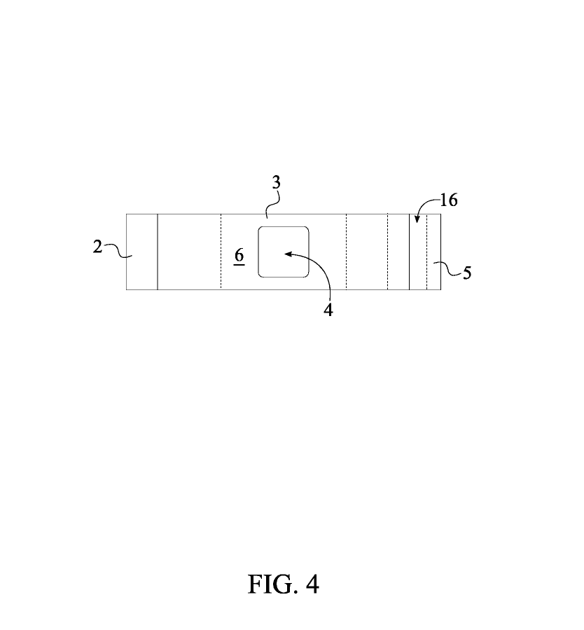

The handle 1 allows the user to securely grasp and apply torque to the present invention during the removal or installation process of the automobile bulb. In reference to FIG. 2 and FIG. 4, the handle 1 comprises a first grip section 2, a middle section 3, and a second grip section 5. The first grip section 2 is terminally connected to the middle section 3. The second grip section 5 is terminally connected to the middle section 3 and positioned opposite of the first grip section 2. The elongated body 7 is terminally connected to the middle section 3 thus resulting the first grip section 2 and the second grip section 5 to be extended beyond lateral walls of the elongated body 7. A bottom surface for the first grip section 2 and the second grip section 5 is oriented towards the open-end wrench head 8 and functions as a grip surface so that the user is able to firmly grasp the present invention and apply torque more tactilely. Furthermore, the elongated body 7 is positioned in between the first grip section 2 and the second grip section 5 thus providing sufficient and equal grip surfaces with respect to the first grip section 2 and the second grip section 5. Optionally, a grip enhancing layer can be superimposed over the grip surface of the first grip section 2 and the second grip section 5 to improve the friction between the handle 1 and the user's fingers. Furthermore, the elongated body 7 and the first grip section 2 are perpendicularly positioned to each other, and the elongated body 7 and the second grip section 5 are perpendicularly positioned to each other. In other words, the elongated body 7 delineates a right angle with the first grip section 2 and the second grip section 5 thus delineating a T-shaped body for the handle 1 and the elongated body 7.

In reference to FIG. 1 and FIG. 4, the present invention further comprises a female square drive 4. More specifically, the female square drive 4 centrally traverses into the middle section 3 from a top surface 6 of the handle 1 as the top surface 6 is positioned opposite to the elongated body 7. The female square drive 4 enables a male square drive of a ratchet extension bar to be engaged with the present invention so that torque can be applied to the present invention through a ratchet and the ratchet extension bar.

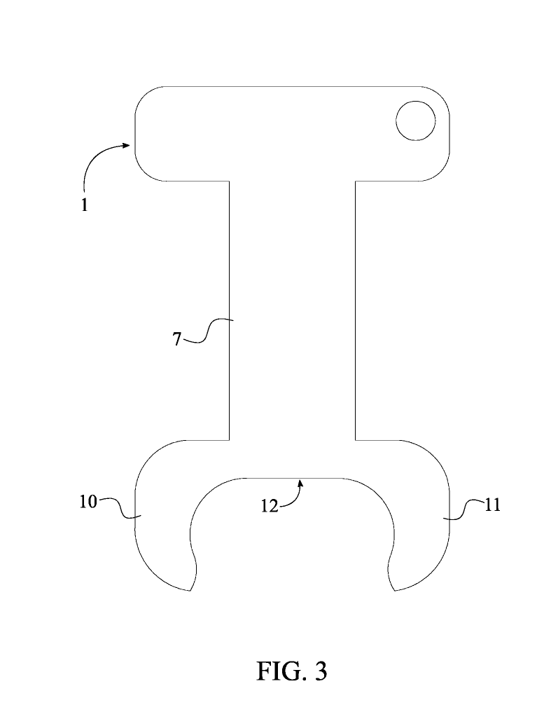

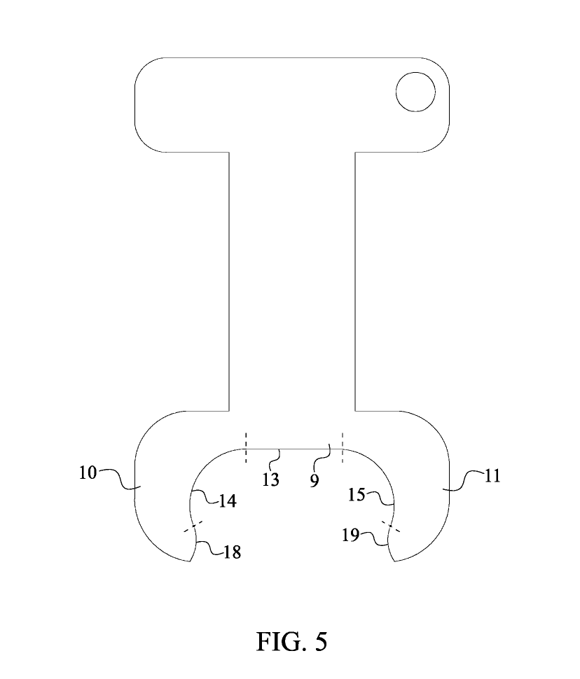

In reference to FIG. 2-3, the present invention further comprises an inner seat profile 12 that is delineated by the cross member 9, the first fixed-jaw 10, and the second fixed-jaw 11. The inner seat profile 12 mimics an outer shape of the automobile bulb base. As a result, the open-end wrench head 8 can be inserted around the automobile bulb base allowing the inner seat profile 12 to securely engage around the automobile bulb base. More specifically, the inner seat profile 12 comprises a straight edge 13, a first concave edge 14, a first convex edge 18, a second concave edge 15, and a second convex edge 19 as shown in FIG. 5. The straight edge 13 is positioned along the cross member 9. The first concave edge 14 and the first convex edge 18 are positioned along the first fixed-jaw 10 and extends up to the straight edge 13. The second concave edge 15 and the second convex edge 19 are positioned along the second fixed-jaw 11 and extends up to the straight edge 13. In other words, the first concave edge 14 and the second concave edge 15 are curved inward toward one another while the first convex edge 18 and the second convex edge 19 are curved outward towards one another. As a result, the first fixed-jaw 10 and the second fixed-jaw 11 expand away from each other during the automobile bulb base engagement due to configuration of the first convex edge 18 and the second convex edge 19, and retrieve back to the original position as the first concave edge 14, the second concave edge 15, the first convex edge 18, and the second convex edge 19 grip the automobile bulb base after the insertion of the open-end wrench head 8. Due to perpendicular positioning of the cross member 9 with reference to the elongated body 7 and the absence of supporting material in between the cross member 9 and the elongated body 7, the cross member 9 functions as an elastic expansion member within the present invention thus allowing the first fixed-jaw 10 and the second fixed-jaw 11 to maintain a rigid body.

In reference to FIG. 5, the first concave edge 14 is positioned adjacent to the straight edge 13. The first convex edge 18 is positioned adjacent to the first concave edge 14 and positioned opposite of the straight edge 13. In other words, the first concave edge 14 extends from the straight edge 13 to a first inflection point of the inner seat profile 12 as the first convex edge 18 extends from the first inflection point to a first end point of the inner seat profile 12. The second concave edge 15 is positioned adjacent to the straight edge 13. The second convex edge 19 is positioned adjacent to the second concave edge 15 and positioned opposite of the straight edge 13. In other words, the second concave edge 15 extends from the straight edge 13 to a second inflection point of the inner seat profile 12 as the second convex edge 19 extends from the second inflection point to a second end point of the inner seat profile 13.

In reference to the preferred embodiment of the present invention, the inner seat profile 12 is able to accurately engage around the following specific automobile bulb bases; HB3, PY20d, PGJ19. However, the inner seat profile 12 can be changed to accurately engage around other types of automobile bulb bases without departing from the spirit and scope of the present invention.

In reference to FIG. 2 and FIG. 4, the present invention further comprises a keychain hole 16 that traverses through the handle 1. The keychain hole 16 allows the user to carry the present invention within a keyring thus maximizing the availability of the present invention to the user. In reference to the exact positioning of the keychain hole 16, the keychain hole 16 can traverse through the first grip section 2 or the second grip section 5, where one does not precede the other.

The present invention is preferably made from Ultra-high-molecular-weight polyethylene (UHMW) to maximize the functionality and improve the reliability of the present invention. However, the present invention is not limited to the UHMW and can be made of other similar types of elastically deform materials such as composite materials, synthetic materials, and plastics.

The present invention can optionally comprise a lighting system to provide illumination during night time hours or low light conditions. The lighting system comprises a bulb, at least one illumination channel, an on/off button, and a power source. More specifically, at least one illumination channel traverse into the elongated body 7 and extends up to the bulb that is integrated within the elongated body 7. The power source is removably positioned within a battery compartment of the handle 1, and the on/off button is integrated onto the handle 1 allowing easy access to the user. The power source is electrically connected to the bulb through the on/off button so that the user is able to selectively turn on the bulb or turn off the bulb through the on/off button thus closing or opening the circuitry within the present invention. Since the bulb is terminally positioned to the at least one illumination channel, light travels through the at least one illumination channel and directs towards the working area when the on/off button closes the electric circuit within the present invention. Furthermore, interior positioning of the bulb and the at least one illumination channel eliminate unnecessary tangles and obstructions that can occur during the usage of the present invention.

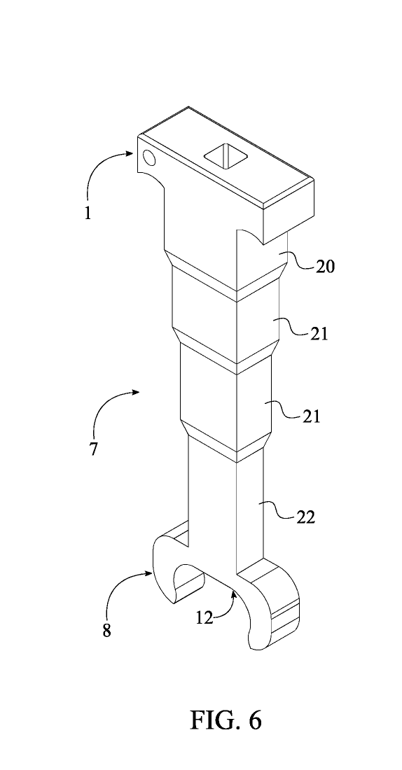

In reference to FIG. 6, an alternative embodiment of the present invention, the elongated body 7 comprises a handle telescopic member 20, at least one intermediary telescopic member 21, and a head telescopic member 22. As a result, the elongated body 7 can function as a telescopic body thus selectively extending and collapsing the distance between the handle 1 and the open-end wrench head 8. More specifically, the handle telescopic member 20 is positioned adjacent to the handle 1. The head telescopic member 22 is positioned adjacent to the open-end wrench head 8. The at least one intermediary telescopic member 21 is positioned in between the handle telescopic member 20 and the head telescopic member 22. The handle telescopic member 20, the at least one intermediary telescopic member 21, and the head telescopic member 22 are telescopically engaged with each other as each member is able to collapse and extend in between the handle 1 and the open-end wrench head 8. Additionally, when the telescopic engagement between the handle telescopic member 20 and the at least one intermediary telescopic member 21 is fully extended, the two members are locked in place through an internal spring-loaded ball lock. Similarly, when the telescopic engagement between the head telescopic member 22 and the at least one intermediary telescopic member 21 is fully extended, the two members are locked in place through another internal spring-loaded ball lock. Even though the handle telescopic member 20, the at least one intermediary telescopic member 21, and the head telescopic member 22 are preferably formed into rectangular shapes within the alternative embodiment, other geometric shapes may be used that include but are not limited to curvilinear, trilinear, polygonal, and so on.

Although the invention has been explained in relation to its preferred embodiment, it is to be understood that many other possible modifications and variations can be made without departing from the spirit and scope of the invention as hereinafter claimed.

What is claimed is:

1. An automobile light wrench comprises:
a handle;
an elongated body;
an open-end wrench head;
an inner seat profile;
the open-end wrench head comprises a cross member, a first fixed-jaw, and a second fixed-jaw;
the first fixed-jaw being terminally connected to the cross member;
the second fixed-jaw being terminally connected to the cross member, opposite of the first fixed-jaw;
the inner seat profile being delineated by the cross member, the first fixed-jaw, and the second fixed-jaw;
the elongated body being terminally connected to the handle;
the elongated body being terminally connected to the cross member, opposite of the handle;
the elongated body being positioned in between the first fixed-jaw and the second fixed-jaw; and
the first fixed-jaw and the second fixed-jaw being oriented away from the elongated body.

2. The automobile light wrench as claimed in claim 1 comprises:
the handle comprises a first grip section, a middle section, and a second grip section;
the first grip section being terminally connected to the middle section;
the second grip section being terminally connected to the middle section, opposite of the first grip section; and
the elongated body being terminally connected to the middle section.

3. The automobile light wrench as claimed in claim 2, wherein the elongated body being positioned in between the first grip section and the second grip section.

4. The automobile light wrench as claimed in claim 2, wherein the elongated body and the first grip section being perpendicularly positioned to each other.

5. The automobile light wrench as claimed in claim 2, wherein the elongated body and the second grip section being perpendicularly positioned to each other.

6. The automobile light wrench as claimed in claim 2 comprises:
a female square drive;
the handle further comprises a top surface;
the top surface being positioned opposite to the elongated body; and
the female square drive centrally traversing into the middle section from the top surface.

7. The automobile light wrench as claimed in claim 1 comprises:
the inner seat profile comprises a straight edge, a first concave edge, a first convex edge, a second concave edge, and a second convex edge;
the straight edge being positioned along the cross member;
the first concave edge and the first convex edge being positioned along the first fixed-jaw; and
the second concave edge and the second convex edge being positioned along the second fixed-jaw.

8. The automobile light wrench as claimed in claim 7 comprises:
the first concave edge being positioned adjacent to the straight edge;
the first convex edge being positioned adjacent to the first concave edge, opposite of the straight edge;
the second concave edge being positioned adjacent to the straight edge; and
the second convex edge being positioned adjacent to the second concave edge, opposite of the straight edge.

9. The automobile light wrench as claimed in claim 1, wherein a keychain hole traverses through the handle.

10. The automobile light wrench as claimed in claim 1, wherein the elongated body is a continuous body with a fixed length.
